(19) United States
(12) Patent Application Publication
(10) Pub. No.: US 2019/0326822 A1
(43) Pub. Date: Oct. 24, 2019

(54) SWITCHING POWER SUPPLY

(71) Applicant: Onkyo Corporation, Osaka (JP)

(72) Inventor: Kei ASAO, Osaka (JP)

(21) Appl. No.: 16/383,619

(22) Filed: Apr. 14, 2019

(30) Foreign Application Priority Data
Apr. 18, 2018 (JP) 2018-079794

(51) Int. Cl. H02M 3/335; H02J 7/00; H02M 1/44; G06F 3/16

(52) U.S. Cl. CPC H02M 3/33523; G06F 3/16; H02M 1/44; H02J 7/0068

(57) ABSTRACT

A switching power supply comprising: a dummy load which is connected to a secondary side.

### CROSS-REFERENCE TO RELATED APPLICATIONS

This application claims priority to Japanese Application No. 2018-079794, filed Apr. 18, 2018, the entire contents of which are incorporated herein by reference.

### FIELD

The present disclosure relates to a switching power supply.

### BACKGROUND

FIG. 6 is a diagram illustrating a conventional fly-back system switching power supply. The switching power supply 101 includes an EMI filter 102, a rectification circuit 103, a condenser C101, a switching element 104, a control IC 105, a transformer 106, a diode D101, a condenser C102, a shunt regulator 107, and a photo coupler 108.

The EMI (ElectroMagnetic Interference) filter 102 removes noise from AC voltage which is input from an AC power supply. The rectification circuit 103 rectifies AC voltage. The condenser C101 smooths voltage which is rectified by the rectification circuit 103. Smoothed voltage is supplied to the switching element 104. The control IC (control circuit) controls the switching element 104. A power supply terminal VDD of the control IC 105 is connected to an auxiliary winding 163 of the transformer 106. The control IC 105 operates according to power supply voltage obtained by rectifying the voltage which is output from the auxiliary winding 163. The switching element 104 is controlled by the control IC 105, and supplies optional frequency AC voltage to a primary winding 161 of the transformer 106 by switching with optional frequency. For example, the switching element 104 is an n type MOSFET. The switching element 104 supplies voltage from the condenser C101 or voltage of a ground potential to the primary winding 161. The transformer 106 changes voltage which is supplied to the primary winding 161 and outputs changed voltage from a secondary winding 162. The diode D101 rectifies AC voltage form the secondary winding 162. The condenser C102 smooths voltage which is rectified by the diode D101. Voltage which is smoothed by the condenser C102 is output voltage of the switching power supply 101.

The shunt regulator 107 is connected to the photo coupler 108 at the secondary side of the switching power supply 101. Further, the shunt regulator 107 changes current which flows to the photo coupler 108 based on output voltage of the switching power supply 101. A reference terminal of the shunt regulator 107 is connected between a resistor R102 and a resistor R103. A cathode of the shunt regulator 107 is connected to the photo coupler 108 (a cathode of a light emitting diode). An anode of the shunt regulator 107 is connected to a ground potential.

The photo coupler 108 (feedback element) has a light emitting diode and a photo transistor. Output voltage of the switching power supply 101 is supplied to an anode of the light emitting diode via the resistor R101. A cathode of the light emitting diode is connected to the shunt regulator 107. A collector of the photo transistor is connected to a feedback terminal FB of the control IC 105. An emitter of the photo transistor is connected to a ground potential. Output voltage of the switching power supply 101 is supplied to one end of a resistor R104. The other end of the resistor R104 is connected to the shunt regulator 107. The control IC 105 is connected to the photo coupler 108 at the primary side of the switching power supply 101.

In the shunt regulator 107, sink current of the cathode increases or decreases based on divide voltage of output voltage of the switching power supply 101 by the resistor R102 and the resistor R103 which is input to the reference terminal. In the shunt regulator 107, the higher voltage of the reference terminal is, the more sink current of the cathode increases. Further, in the shunt regulator 107, the lower voltage of the reference terminal is, the more sink current of the cathode decreases.

In the photo coupler 108, current of the light emitting diode increases or decreases based on increase or decrease of sink current of the shunt regulator 107. Increase or decrease of current of the photo transistor changes voltage of the feedback terminal FB of the control IC 105. Herein, a power supply is connected to the feedback terminal FB of the control IC 105 via a resistor. For this reason, the more current of the photo transistor increases, the more voltage of the feedback terminal FB decreases. The control IC 105 adjusts output voltage of the switching power supply 101 by changing duty of ON/OFF by the switching element 104 based on voltage of the feedback terminal FB.

The control IC mounts burst mode which stops switching to reduce electric power consumption at standby and light load (see JP 2010-206949 A with regard to the burst mode.) An audio or the like such as a class D amplifier consumes large electric power at large signal, however it consumes almost no electric power at small signal. The switching power supply which includes the control IC which mounts the burst mode transits to the burst mode because of light load at small signal. The burst mode has adverse effect in sound quality (quality level) because it occurs at a cycle in which the frequency is within the audible band.

It is necessary that the following condition is satisfied to finish the burst mode.

Electric power which is transmitted from the primary side to the secondary side at continuous operation≤electric power which is output from the secondary side

Namely, when the switching power supply supplies electric power to an audio system, if regular electric power consumption of the audio system is smaller than electric power which is transmitted from the primary side to the secondary side at continuous operation, the switching power supply becomes the burst mode.

The control IC controls frequency of PWM based on voltage V_{FB} of the feedback terminal. FIG. 7 is a diagram illustrating relationship of frequency of PWM and voltage V_{FB} of the feedback terminal. A horizontal axis illustrates voltage V_{FB}, and a vertical axis illustrates frequency. When voltage V_{FB} is not less than V_{FB-N}, frequency is constant with 65 kHz. When voltage V_{FB} is between V_{FB-N} and V_{FB-G}, OFF time of the switching element changes and frequency changes between 23 kHz and 65 kHz. When Voltage V_{FB} is between V_{FB-G} and V_{FB-ZDC}, frequency is 23 kHz. When voltage V_{FB} becomes smaller than V_{FB-ZDC}, the switching element becomes OFF. When voltage V_{FB} becomes V_{FB-ZDCR}, the switching element becomes ON, and frequency becomes 23 kHz.

Herein, the larger output voltage is, the higher V_{FB} becomes. When output voltage is small and V_{FB} becomes smaller than a predetermined threshold (above-mentioned V_{FB-ZDC}), the burst occurs (switching stops). Thus, output voltage descends and V_{FB} rises because of correction. When V_{FB} becomes larger than a predetermined threshold (above-mentioned V_{FB-ZDCR}), switching starts. This repetition is the burst mode.

FIG. 8 is a diagram illustrating a part of FIG. 6. A current detection resistor R105 is connected to a source of the switching element 104. Further, a sense terminal SENSE of the control IC 105 is connected between the source of the switching element 104 and the current detection resistor R105 via a resistor R106.

The control IC 105 has a current limit function. Concretely, when voltage V_{SENSE} of the sense terminal SENSE reaches to 0.8V, the control IC 105 stops operation of the switching element 104 for current protection. Further, the control IC 105 has a function which controls duty of PWM as described above. The control IC 105 decides ON time of the switching element 104 based on V_{SENSE} and V_{COMP}. Herein, V_{COMP}=(V_{FB}−0.6)/4. When V_{SENSE} reaches to V_{COMP}, the control IC 105 sets the switching element 104 OFF immediately. The shorter ON time of the switching element 104 is, the smaller electric power which is transmitted to the secondary side per switching is. Namely, current at continuous operation starting becomes small. As a problem, when maximum current (current limit value) increases, the resistor value of the current detection resistor R105 must below. In this case, as illustrated in FIG. 9, ON time of the switching element 104 extends because time that V_{SENSE} reaches to V_{COMP} extends.

There is a problem that a transition to burst mode occurs when the ON time of a switching element is long and electric power which is transmitted from the primary side to the secondary side at continuous operation becomes large. In an invention according to JP 2017-171700 by the applicant, transition to the burst mode is avoided by shortening ON time of the switching element.

### SUMMARY OF THE INVENTION

According to one aspect of the disclosure, there is provided a switching power supply comprising: a dummy load which is connected to a secondary side.

### BRIEF DESCRIPTION OF THE DRAWINGS

FIG. 1 is a diagram illustrating a circuit configuration of a switching power supply according to a first embodiment of the present invention.

FIG. 2 is a diagram illustrating the circuit configuration of the switching power supply according to the first embodiment of the present invention.

FIG. 3 is a diagram illustrating the circuit configuration of a switching power supply according to a second embodiment of the present invention.

FIG. 4 is a diagram illustrating the circuit configuration of the switching power supply according to the second embodiment of the present invention.

FIG. 5 is a diagram illustrating the circuit configuration of the switching power supply according to the second embodiment of the present invention.

FIG. 6 is a diagram illustrating a conventional fly-back type switching power supply.

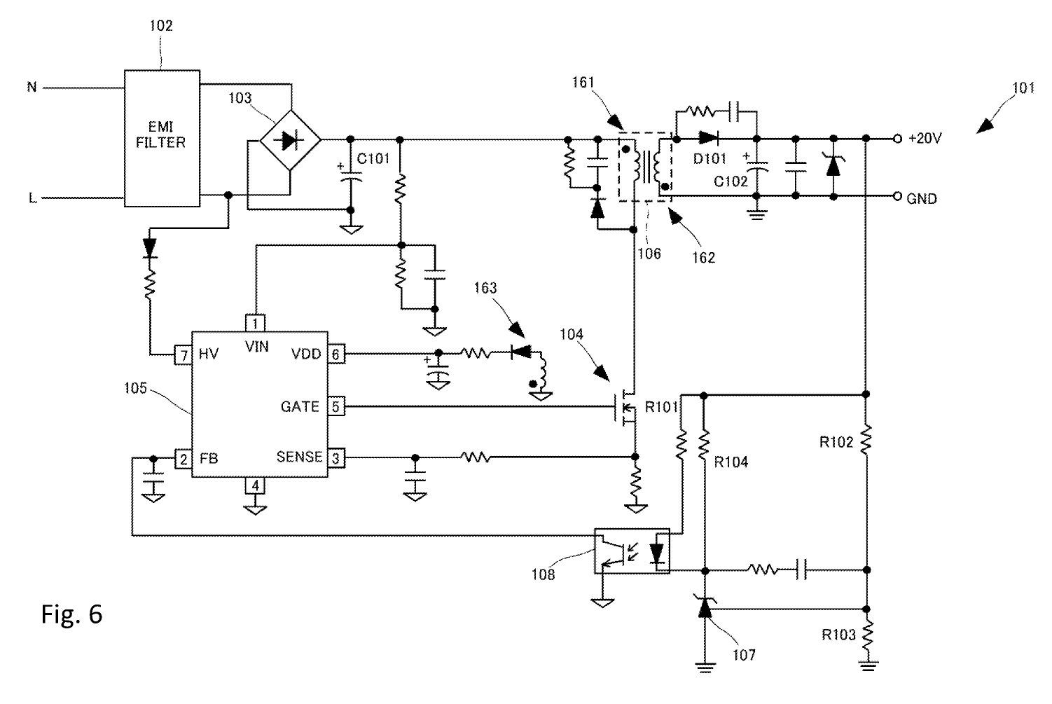

FIG. 7 is a diagram illustrating relationship of frequency of PWM and voltage of a feedback terminal.

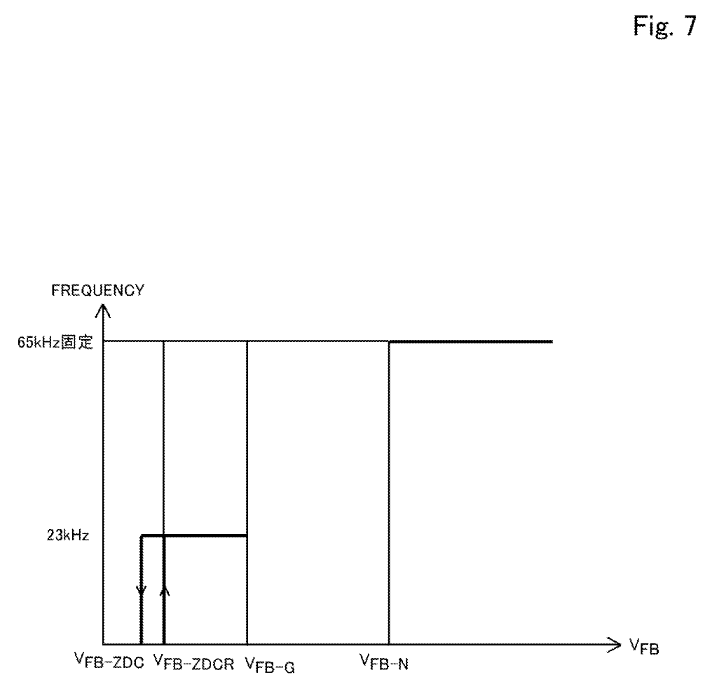

FIG. 8 is a diagram illustrating a part of FIG. 6.

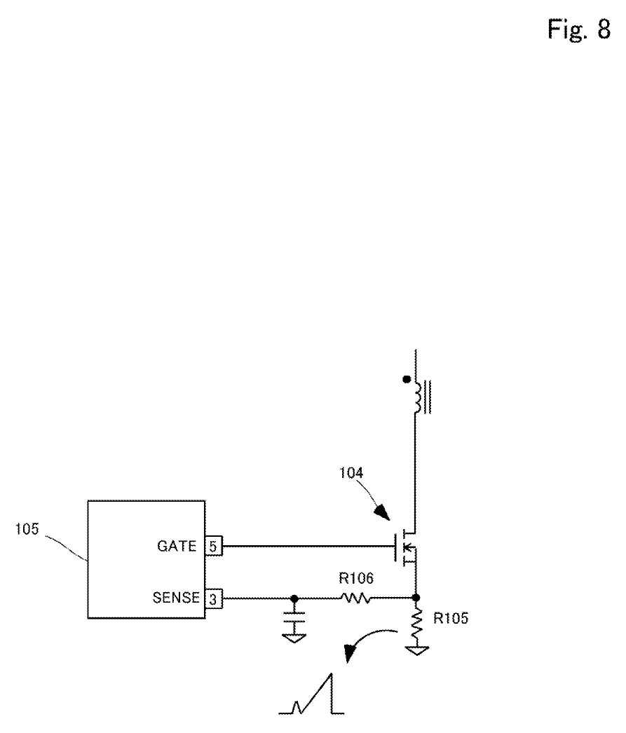

FIG. 9 is a diagram illustrating voltage of a sense terminal.

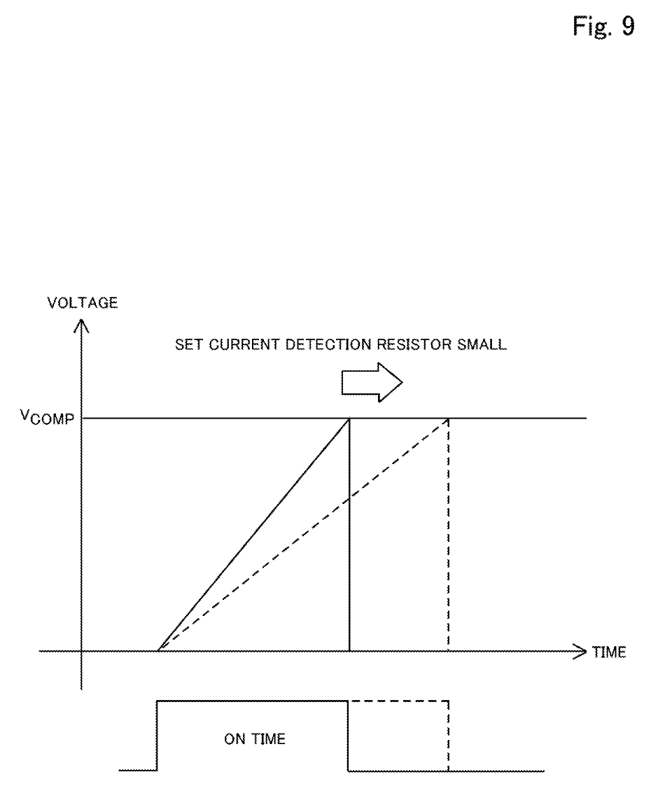

### DETAILED DESCRIPTION OF THE PREFERRED EMBODIMENTS

An objective of the present disclosure is to provide a switching power supply which does not transit to burst mode.

An embodiment of the present invention is described below.

### First Embodiment

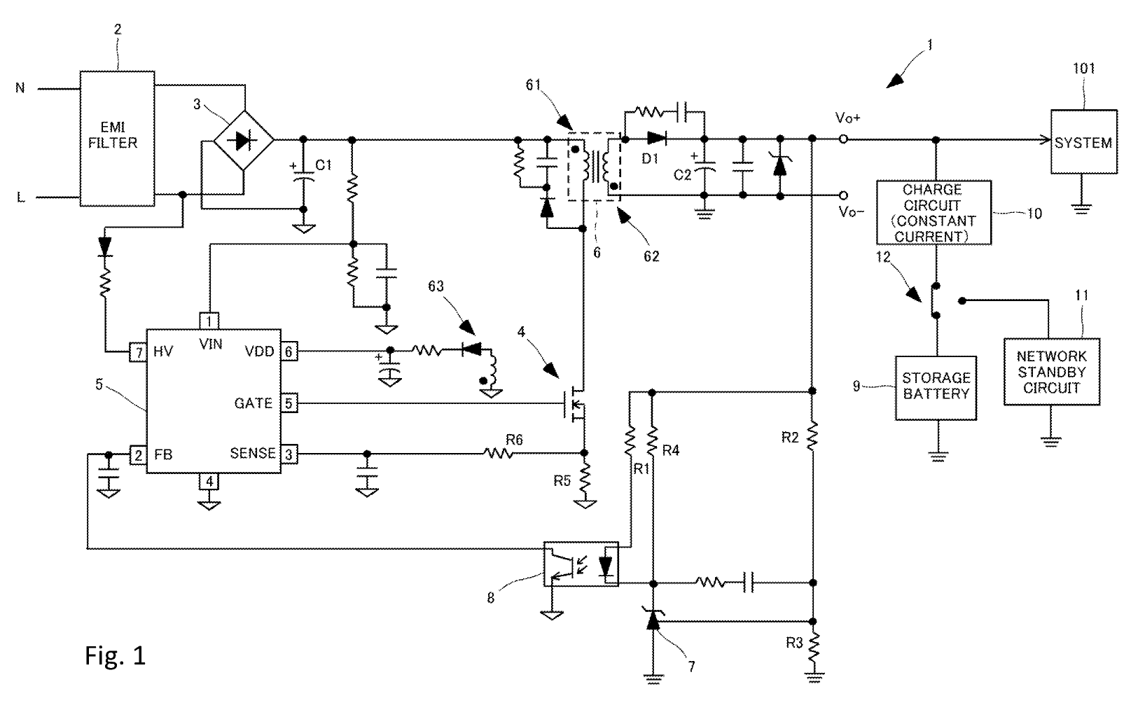

FIG. 1 is a diagram illustrating a circuit configuration of a switching power supply according to a first embodiment of the present invention. The switching power supply 1 includes an EMI filter 2, a rectification circuit 3, a condenser C1, a switching element 4, a control IC 5, a transformer 6, a diode D1, a condenser C2, a shunt regulator 7, and a photo coupler 8.

The EMI (Electro Magnetic Interference) filter 2 removes noise from AC voltage which is input from an AC power supply. The rectifier circuit 3 rectifies AC voltage. The condenser C1 smooths voltage which is rectified by the rectifier circuit 3. Smoothed voltage is supplied to the switching element 4. The control IC 5 (control circuit) controls the switching element 4. A power supply terminal VDD of the control IC 5 is connected to an auxiliary winding 63 of the transformer 6. The control IC 5 operates according to power supply voltage obtained by rectifying the voltage output from the auxiliary winding 63. The switching element 4 is controlled by the control IC 5 and supplies optional frequency AC voltage to a primary winding 61 of the transformer 6 by switching with optional frequency. For example, the switching element 4 is an n type MOSFET. The switching element 4 supplies voltage from the condenser C1 or voltage of a ground potential to the primary winding 61. The transformer 6 changes voltage which is supplied to the primary winding 61 and outputs changed voltage from the secondary winding 62. The diode D1 rectifies AC voltage from the secondary winding 62. The condenser C2 smooths voltage which is rectified by the diode D1. Voltage which is smoothed by the condenser C2 is output voltage of the switching power supply 1.

Output voltage from the switching power supply 1 is supplied to a system 101.

The shunt regulator 7 (voltage detection element) is connected to the photo coupler 8 at the secondary side of the switching power supply 1. Further, the shunt regulator 7 changes current which flows to the photo coupler 8 based on output voltage of the switching power supply 1. A reference terminal of the shunt regulator 7 is connected between a resistor R2 and a resistor R3. A cathode of the shut regulator 7 is connected to the photo coupler 8 (a cathode of a light emitting diode). An anode of the shunt regulator 7 is connected to a ground potential.

The photo coupler 8 (feedback element) has a light emitting diode and a photo transistor. Output voltage of the switching power supply 1 is supplied to an anode of the light emitting diode via the resistor R1. A cathode of the light emitting diode is connected to the shunt regulator 7. A collector of the photo transistor is connected to a feedback terminal FB of the control IC 5. An emitter of the photo transistor is connected to a ground potential. Output voltage of the switching power supply 1 is supplied to one end of a resistor R4. The other end of the resistor R4 is connected to the shunt regulator 7. The control IC 5 is connected to the photo coupler 8 at the primary side of the switching power supply 1.

In the shunt regulator 7, sink current of the cathode increases or decreases based on divide voltage of output voltage of the switching power supply 1 by the resistor R2 and the resistor R3 which is input to the reference terminal. In the shunt regulator 7, the higher voltage of the reference terminal is, the more sink current of cathode increases. Further, in the shunt regulator 7, the lower voltage of the reference terminal is, the more sink current of the cathode decreases.

In the photo coupler 8, current of the light emitting diode increases or decreases based on increase or decrease of sink current of the shunt regulator 7. Increase or decrease of current of the photo transistor changes voltage of the feedback terminal FB of the control IC 5. Herein, power supply is connected to the feedback terminal FB of the control IC 5 via a resistor. For this reason, the more current of the photo transistor increases, the more voltage of the feedback terminal FB decreases. The control IC 5 adjusts output voltage of the switching power supply 1 by changing duty of ON/OFF by the switching element 4 based on voltage of the feedback terminal FB.

A current detection resister R5 is connected to a source of the switching element 4. The control IC 5 controls normal mode and burst mode based on voltage V_{SENSE} which generates at the sense terminal SENSE (first terminal) and value V_{COMP} based on voltage V_{FB} which generates at the feedback terminal FB (second terminal).

The switching power supply 1 further includes a storage battery 9, a charge circuit 10, a network standby circuit 11, and a switch 12. The storage battery 9 and the charge circuit 10 are connected at the secondary side of the switching power supply 1. The storage battery 9 (dummy load) is charged by constant current which is supplied from the charge circuit 10 (charge). Further, the storage battery 9 supplies electric power to the network standby circuit 11 (discharge). The charge circuit 10 supplies constant current to the storage battery 9. The network standby circuit 11 functions as a supply source of a standby power supply in network standby. The switch 12 connects between the storage battery 9 and the charge circuit 10 or between the storage battery 9 and the network standby circuit 11.

In normal, as illustrated in FIG. 1, the switch 12 connects between the storage battery 9 and the charge circuit 10. The storage battery 9 is charged by electric power from the charge circuit 10. Thus, continuous switching operation always continues and the switching power supply 1 does not transit to the burst mode because electric power consumption at the secondary side does not become small. Further, electric power is not consumed waste fully because electric power is stored in the storage battery 9 by using the storage battery 9 as a dummy load to suppress the decrease of the power consumption.

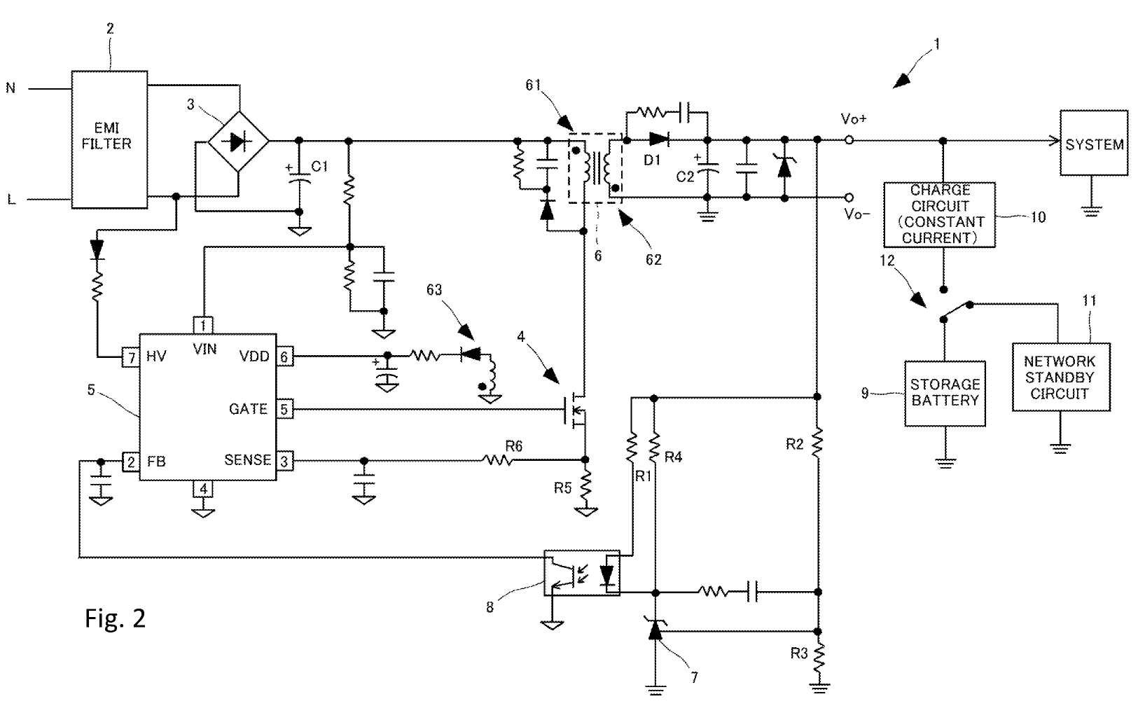

In network standby, as illustrated in FIG. 2, the switch 12 connects between the storage battery 9 and the network standby circuit 11. Thus, electric power is supplied from the storage battery 9 to the network standby circuit 11.

### Second Embodiment

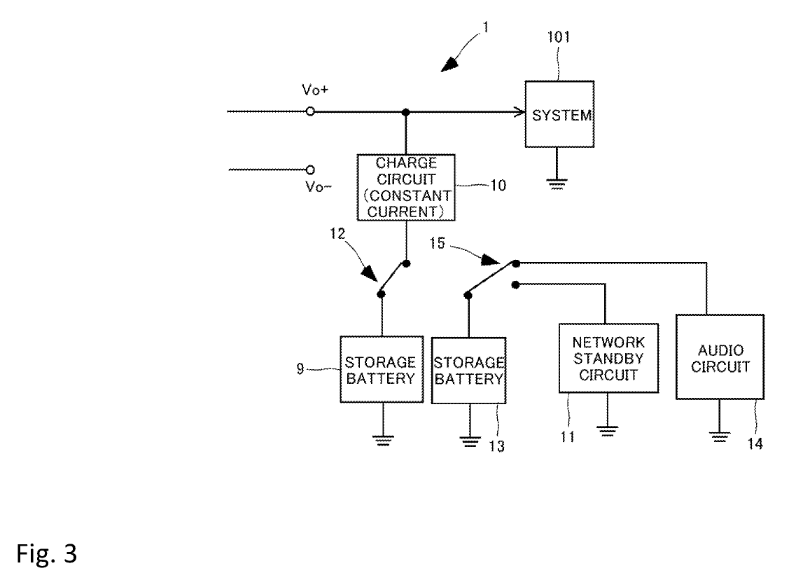

Each of FIG. 3 to FIG. 5 is a diagram illustrating the circuit configuration of a switching power supply according to a second embodiment of the present invention. The switching power supply 1 further includes a storage battery 13, an audio circuit 14, and a switch 15. The storage battery 9 is charged by constant current which is supplied from the charge circuit 10 (charge). The storage battery 9 supplies electric power to the network standby circuit 11 or the audio circuit 14 (discharge). The charge circuit 10 supplies constant current to the storage battery 9 or storage battery 13. The switch 12 connects between the storage battery 9 and the charge circuit 10, between the storage battery 9 and the network standby circuit 11 or between the storage battery 9 and the audio circuit 14.

The storage battery 13 (dummy load) is charged by constant current which is supplied from the charge circuit 10 (charge). Further, the storage battery 13 supplies electric power to the network standby circuit 11 or the audio circuit 14 (discharge). The audio circuit 14 (music reproduction circuit) includes a D/A converter, an amplifier and so on, and is a circuit for reproducing music. The switch 15 connects between the storage battery 13 and the charge circuit 10, between the storage battery 13 and the network standby circuit 11 or between the storage battery 13 and the audio circuit 14.

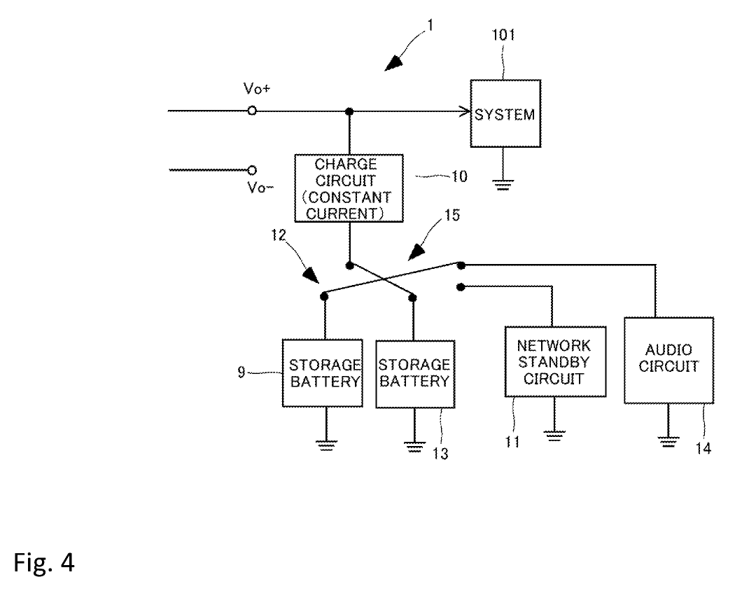

In music reproduction, as illustrated in FIG. 3, the switch 12 connects between the storage battery 9 and the charge circuit 10. Further, the switch 15 connects between the storage battery 13 and the audio circuit 14. Thus, the audio circuit 14 is not affected by voltage change of the switching power supply 1 and sound quality of reproduced music improves because electric power from the storage battery 13 which is insulated with the switching power supply 1 is supplied to the audio circuit 14. When remaining amount of the storage battery 13 becomes small (for example, remaining amount is 0 (not more than a predetermined value)), as illustrated in FIG. 4, the switch 15 connects between the storage battery 13 and the charge circuit 10. Further, the switch 12 connects the storage battery 9 and the audio circuit 14. Thus, music reproduction can continue.

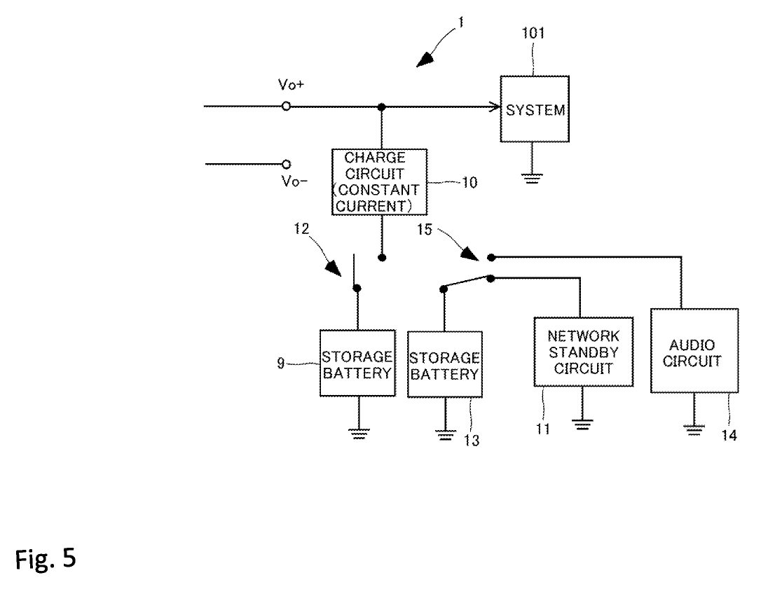

In network standby, as illustrated in FIG. 5, the switch 15 connects between the storage battery 13 and the network standby circuit 11. The switch 12 does not connect between the storage battery 9 and the charge circuit 10. Alternatively, in network standby, the switch 12 connects between the storage battery 9 and the network standby circuit 11. The switch 15 does not connect the storage battery 13 and the charge circuit 10.

The embodiment of the present invention is described above, but the mode to which the present invention is applicable is not limited to the above embodiment and can be suitably varied without departing from the scope of the present invention.

In the above-described embodiment, as the dummy load, the storage battery is illustrated. Not limited to this, the dummy load may be a resistor or the like. “Dummy load” is a load other than a load that the switching power supply 1 originally supplies power supply voltage (in the above-described embodiments, system 101).

In the above-described first embodiment, electric power from the storage battery 9 is supplied to the network standby circuit 11. Electric power form the storage battery may be supplied to the other circuit such as an audio circuit (music reproduction circuit) or the like.

In the above-described second embodiment, the switching power supply 1 includes two storage batteries 9 and 13. Not limited to this, the switching power supply 1 may include three or more storage batteries. Further, instead of one storage battery, a dummy load such as a resistor or the like may be provided. For example, when the storage battery is fully charged, the dummy load may be connected to a charge circuit.

The present invention can be suitably employed in a switching power supply.

What is claimed is:

1. A switching power supply comprising:
a dummy load which is connected to a secondary side.

2. The switching power supply according to claim 1,
wherein the dummy load is a storage battery.

3. The switching power supply according to claim 2 further comprising:
a charge circuit which is connected to the secondary side and supplies constant current to the storage battery.

4. The switching power supply according to claim 3, further comprising a switch,
wherein the switch connects between the storage battery and the charge circuit or a circuit.

5. The switching power supply according to claim 4,
wherein the circuit is a network standby circuit which functions as a supply source of a standby power supply in network standby.

6. The switching power supply according to claim 4,
wherein the circuit is a music reproduction circuit.

7. The switching power supply according to claim 4,
wherein the switch connects between the storage battery and the charge circuit at a normal time.

8. The switching power supply according to claim 5,
wherein the switch connects between the storage battery and the network standby circuit in network standby.

9. The switching power supply according to claim 4, further comprising:
multiple storage batteries; and
multiple switches,
wherein the circuit is a music reproduction circuit,
in reproduction, anyone of the multiple switches connects between any one of the multiple storage batteries and the music reproduction circuit, and
any one of the multiple switches connects between any one the multiple storage batteries and the charge circuit.

10. The switching power supply according to claim 9,
wherein any one of the multiple switches connects the other storage battery and the music reproduction circuit when the remaining amount of the storage battery which is connected to the music reproduction circuit becomes not more than a predetermined value, and
any one of the multiple switches connects the charge circuit and the storage battery in which the remaining amount is not more than a predetermined value

11. The switching power supply according to claim 4, further comprising:
multiple storage batteries; and
multiple switches,
wherein the circuit is a network standby circuit,
in network standby,
any one of the multiple switches connects between anyone of the multiple storage batteries and the network standby circuit, and
the other switch does not connect between the other storage battery and the charge circuit.

12. The switching power supply according to claim 1, further comprising:
a voltage detection element which is connected to a feedback terminal at the secondary side and changes current which flows to the feedback terminal based on output voltage of the switching power supply;
a control circuit which is connected to the feedback element at the primary side of the switching power supply and controls the switching element; and
a current detection resistor which is connected to the switching element,
wherein the control circuit controls burst mode or normal mode based on voltage which generates on a first terminal which is connected between the current detection resistor and the switching element and a value based on voltage which generates on a second terminal which is connected to the feedback element.
